(19) United States
(12) Patent Application Publication
(10) Pub. No.: US 2013/0058626 A1
(43) Pub. Date: Mar. 7, 2013

(54) SYSTEM AND METHOD FOR SERVER-BASED PERSONAL VIDEO RECORDING AND RETRIEVAL

(71) Applicants: Michael A. Avina, Tampa, FL (US); Timothy M. Roberts, Tampa, FL (US)

(72) Inventors: Michael A. Avina, Tampa, FL (US); Timothy M. Roberts, Tampa, FL (US)

(73) Assignee: SAVTIRA CORPORATION, Tampa, FL (US)

(21) Appl. No.: 13/404,758

(22) Filed: Feb. 24, 2012

Related U.S. Application Data
(60) Provisional application No. 61/446,184, filed on Feb. 24, 2011.

(51) Int. Cl. H04N 9/80

(52) U.S. Cl. 386/241; 386/E09.011

(57) ABSTRACT

The disclosed embodiments relate to a method, an apparatus, and computer-readable medium storing computer-readable instructions for recording and retrieving videos.

### RELATED APPLICATION DATA

This application claims priority to U.S. Provisional Application No. 61/446,184, filed Feb. 24, 2011, which is hereby incorporated by reference in its entirety.

### SUMMARY

The disclosed embodiment relates to a server-based personal video recorder that comprises a video storage system capable of retrieving and storing a continuous stream of video or audio to a centralized or distributed disk, a storage system capable of retrieving and storing the time start and time stop points requested by a particular user for a particular stream of video, a user interface that provides a user or consumer with the capability to select which channel, and which particular timeframe of video that the user would like to record, a user interface that provides channel managers or publishers with the capability to set pricing and subscription usage for users seeking to record and view their channels, and a user interface that provides users with the capability to share their selection of recorded videos with other users. The time start and time stop points can coincide with the start and stop times for a particular program, including any advertisements. Advertisements can be excluded by incorporating stop and start points for each segment of advertising. The stored video can include a continuous stream of either audio or video. The video can be transcoded into multiple formats in order to be suitable for viewing on either handheld or television devices. The consumer can select their device, pre-select channels to record, and manage their subscription settings. Channel managers can enable per-minute or per-hour fees to view and record their content, and can set recorded content to expire depending on user subscription settings.

The disclosed embodiment further relates to a method for video recording and retrieval. An exemplary method comprises retrieving and storing a continuous stream of video or audio to a centralized or distributed disk, retrieving and storing the time start and time stop points requested by a particular user for a particular stream of video, providing a user or consumer with the capability to select which channel, and which particular timeframe of video that the user would like to record, providing channel managers or publishers with the capability to set pricing and subscription usage for users seeking to record and view their channels, and providing users with the capability to share their selection of recorded videos with other users.

Furthermore, the disclosed embodiment relates to an apparatus for video recording and retrieval. An exemplary apparatus comprises one or more processors, and one or more memories operatively coupled to at least one of the one or more processors and containing instructions that, when executed by at least one of the one or more processors, cause at least one of the one or more processors to retrieve and store a continuous stream of video or audio to a centralized or distributed disk, retrieve and store the time start and time stop points requested by a particular user for a particular stream of video, provide a user or consumer with the capability to select which channel, and which particular timeframe of video that the user would like to record, provide channel managers or publishers with the capability to set pricing and subscription usage for users seeking to record and view their channels, and provide users with the capability to share their selection of recorded videos with other users.

Moreover, the disclosed embodiment relates to at least one non-transitory computer-readable medium storing computer-readable instructions that, when executed by one or more computing devices, record and retrieve videos. Exemplary instructions cause at least one of the one or more computing devices to retrieve and store a continuous stream of video or audio to a centralized or distributed disk, retrieve and store the time start and time stop points requested by a particular user for a particular stream of video, provide a user or consumer with the capability to select which channel, and which particular timeframe of video that the user would like to record, provide channel managers or publishers with the capability to set pricing and subscription usage for users seeking to record and view their channels, and provide users with the capability to share their selection of recorded videos with other users.

### BRIEF DESCRIPTION OF THE DRAWINGS

FIG. 1 illustrates an exemplary embodiment.

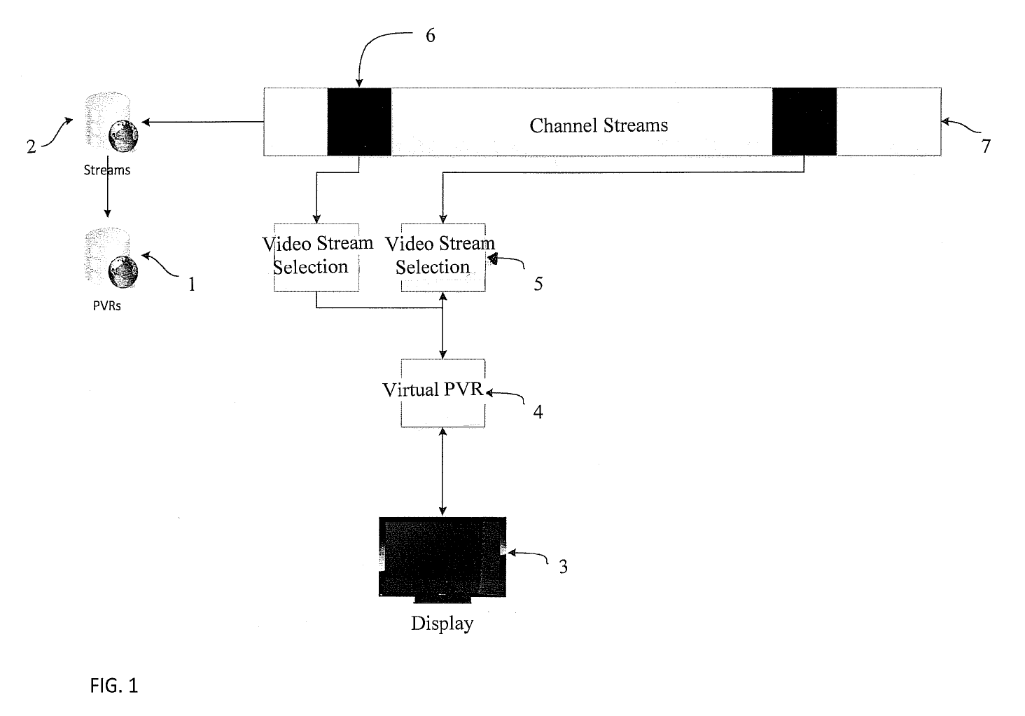

FIG. 2 illustrates an exemplary computing device according to the disclosed embodiment.

### DETAILED DESCRIPTION

Referring to the figures, the disclosed embodiment describes a personal video recorder that can be hosted within a server-based environment. This is an advancement over existing personal video recorders in this it is significantly lower cost to deliver, and provides for the capability for users to access their portfolio of recorded content from anywhere and share their recorded content with other users of the same personal recording service.

A personal video recorder is typically a consumer electronics device or. software that records video in a digital format to a disk drive, flash drive or memory card. The term includes set-top boxes with a recording facility, portable media players, recorders and software for personal computers which enables a user to capture video or music and playback from the disk. Televisions with built-in personal video recorders have been introduced as well.

The disclosed embodiment, a server-based personal video recorder, allows a user to record media even when the user does not have a subscription to watch a particular channel. For example, a service provider can provide time-based usage subscription fees to a user and only charge the user for the amount of video actually recorded. This type of consumption based usage and delivery could allow channels to significantly improve their revenue, while simplifying the delivery of user-preferred content.

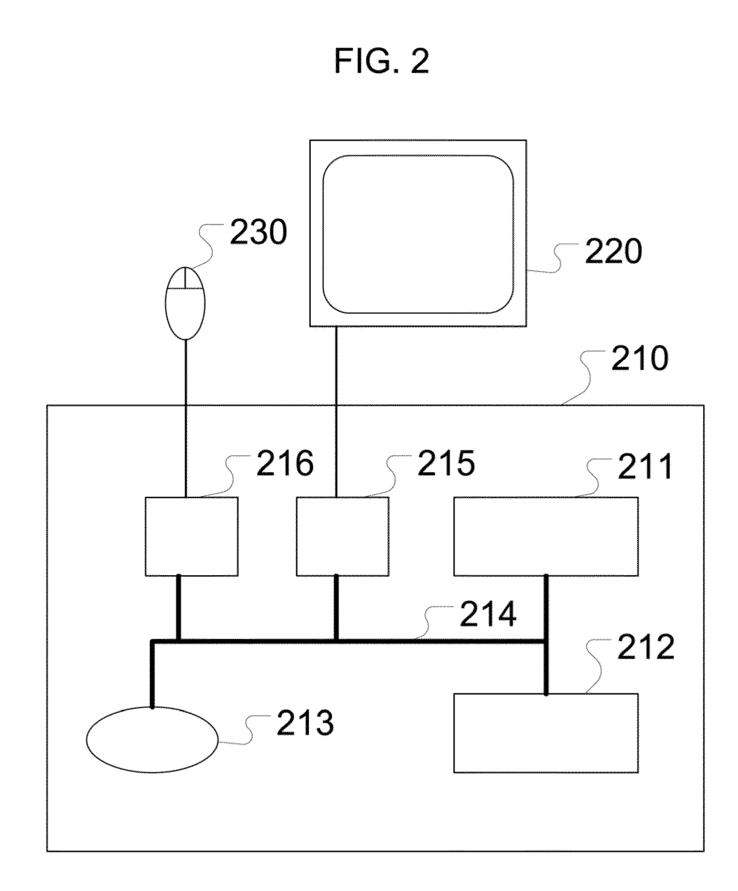

The embodiments described herein may be implemented with any suitable hardware and/or software configuration, including, for example, modules executed on computing devices such as computing device 210 of FIG. 2. Embodiments may, for example, execute modules corresponding to steps shown in the methods described herein. Of course, a single step may be performed by more than one module, a single module may perform more than one step, or any other logical division of steps of the methods described herein may be used to implement the processes as software executed on a computing device.

Computing device 210 has one or more processing device 211 designed to process instructions, for example computer readable instructions (i.e., code) stored on a storage device 213. By processing instructions, processing device 211 may perform the steps set forth in the methods described herein. Storage device 213 may be any type of storage device (e.g., an optical storage device, a magnetic storage device, a solid state storage device, etc.), for example a non-transitory storage device. Alternatively, instructions may be stored in remote storage devices, for example storage devices accessed over a network or the internet. Computing device 210 additionally has memory 212, an input controller 216, and an output controller 215. A bus 214 operatively couples components of computing device 210, including processor 211, memory 212, storage device 213, input controller 216, output controller 215, and any other devices (e.g., network controllers, sound controllers, etc.). Output controller 215 may be operatively coupled (e.g., via a wired or wireless connection) to a display device 220 (e.g., a monitor, television, mobile device screen, touch-display, etc.) In such a fashion that output controller 215 can transform the display on display device 220 (e.g., in response to modules executed). Input controller 216 may be operatively coupled (e.g., via a wired or wireless connection) to input device 230 (e.g., mouse, keyboard, touch-pad, scroll-ball, touch-display, etc.) In such a fashion that input can be received from a user (e.g., a user may input with an input device 230 a dig ticket).

Of course, FIG. 2 illustrates computing device 210, display device 220, and input device 230 as separate devices for ease of identification only. Computing device 210, display device 220, and input device 230 may be separate devices (e.g., a personal computer connected by wires to a monitor and mouse), may be integrated in a single device (e.g., a mobile device with a touch-display, such as a smartphone or a tablet), or any combination of devices (e.g., a computing device operatively coupled to a touch-screen display device, a plurality of computing devices attached to a single display device and input device, etc.). Computing device 210 may be one or more servers, for example a farm of networked servers, a clustered server environment, or a cloud network of computing devices.

While systems and methods are described herein by way of example and embodiments, those skilled in the art recognize that disclosed systems and methods are not limited to the embodiments or drawings described. It should be understood that the drawings and description are not intended to be limiting to the particular form disclosed. Rather, the intention is to cover all modifications, equivalents and alternatives falling within the spirit and scope of the appended claims. Any headings used herein are for organizational purposes only and are not meant to limit the scope of the description or the claims. As used herein, the word “may” is used in a permissive sense (i.e., meaning having the potential to), rather than the mandatory sense (i.e., meaning must). Similarly, the words “include”, “including”, and “includes” mean including, but not limited to.

Various embodiments of the disclosed embodiment have been disclosed herein. However, various modifications can be made without, departing from the scope of the embodiments as defined by the appended claims and legal equivalents.

What is claimed is:

1. A method for video recording and retrieval, the method comprising:
retrieving and storing a continuous stream of video or audio to a centralized or distributed disk;
retrieving and storing the time start and time stop points requested by a particular user for a particular stream of video;
providing a user or consumer with the capability to select which channel, and which particular timeframe of video that the user would like to record;
providing channel managers or publishers with the capability to set pricing and subscription usage for users seeking to record and view their channels; and
providing users with the capability to share their selection of recorded videos with other users.

2. An apparatus for video recording and retrieval, the apparatus comprising:
one or more processors; and
one or more memories operatively coupled to at least one of the one or more processors and containing instructions that, when executed by at least one of the one or more processors, cause at least one of the one or more processors to:
retrieve and store a continuous stream of video or audio to a centralized or distributed disk;
retrieve and store the time start and time stop points requested by a particular user for a particular stream of video;
provide a user or consumer with the capability to select which channel, and which particular timeframe of video that the user would like to record;
provide channel managers or publishers with the capability to set pricing and subscription usage for users seeking to record and view their channels; and
provide users with the capability to share their selection of recorded videos with other users.

3. At least one non-transitory computer-readable medium storing computer-readable instructions that, when executed by one or more computing devices, record and retrieve videos, the instructions causing at least one of the one or more computing devices to:
retrieve and store a continuous stream of video or audio to a centralized or distributed disk;
retrieve and store the time start and time stop points requested by a particular user for a particular stream of video;
provide a user or consumer with the capability to select which channel, and which particular timeframe of video that the user would like to record;
provide channel managers or publishers with the capability to set pricing and subscription usage for users seeking to record and view their channels; and
provide users with the capability to share their selection of recorded videos with other users.
